(19) United States
(12) Patent Application Publication
(10) Pub. No.: US 2009/0056298 A1
(43) Pub. Date: Mar. 5, 2009

(54) Over-Retraction Limiter for the Fingers of a Retracting Finger Auger Mechanism

(75) Inventors: Randy Lohrentz, Buhler, KS (US); Robert Honas, Newton, KS (US); Stanley R. Clark, Hesston, KS (US)

Correspondence Address: HOVEY WILLIAMS LLP, 10801 Mastin Blvd., Suite 1000, Overland Park, KS, 66210, US

(73) Assignee: AGCO CORPORATION, Duluth, GA (US)

(21) Appl. No.: 11/846,286

(22) Filed: Aug. 28, 2007

(51) Int. Cl. A01D 89/00

(52) U.S. Cl. 56/364

(57) ABSTRACT

A retracting finger auger assembly is provided with a limiter inside the auger tube of the assembly that is disposed to make temporary engagement with the internal eccentrically offset finger shaft of the retracting finger mechanism in the event of flexure of the finger shaft beyond a predetermined amount. In a preferred embodiment, the limiter comprises a transverse, annular member with a guide ring of anti-friction material circumscribing the finger shaft, the member being secured to the interior surface of the auger tube for rotation therewith. The anti-friction guide ring is normally maintained slightly out of contacting engagement with the finger shaft, but is disposed to be engaged as necessary by the flexing shaft to limit such flexing and prevent over-retraction of the retracting fingers.

### TECHNICAL FIELD

The present invention relates to retracting finger auger assemblies utilized in grain harvesting headers and the like and, more particularly, to a retracting finger auger assembly having means for preventing the fingers thereof from retracting too far into the auger tube and causing damage or catastrophic failure.

### BACKGROUND AND SUMMARY

Retracting finger auger assemblies are well known in the art and have been used for many years to converge crop materials centrally and then feed them rearwardly. Typically, the auger assembly is set up such that the fingers extend as they engage crop material at the front of the auger and retract as they release material at the back.

A typical retracting finger auger assembly has a stationary crank shaft within the auger tube and fingers that are pivotally mounted on an eccentrically offset finger shaft portion of the crank shaft. The auger tube rotates while the crank shaft remains stationary, but because the fingers project outwardly through holes in the auger tube, they are driven around the finger shaft by the auger tube as it rotates. Because the auger tube rotates about one axis while the fingers pivot about the axis of the offset finger shaft, the fingers extend and retract through the holes in the auger tube as they revolve about the finger shaft.

In some conditions, particularly if the finger shaft is long and unsupported in the middle, the finger shaft can bounce around within the auger tube and flex to such an extent that one or more of the fingers may become over-retracted into the interior of the auger tube. When that happens, significant damage and catastrophic failures can result.

Accordingly, the present invention is intended to eliminate this over-retraction problem. In a preferred embodiment, each long run of a finger shaft within an auger tube is provided with a flex limiter that is disposed to block excessive flexing of the finger shaft. Anti-friction surfaces associated with the flex limiter are secured to the auger tube for movement therewith relative to the finger shaft but are disposed to be engaged by the finger shaft when necessary to prevent untoward flexing.

### BRIEF DESCRIPTION OF THE DRAWINGS

FIG. 1 is a left front isometric view of a harvesting header utilizing a retracting finger auger assembly in accordance with the principles of the present invention, portions of the harvesting reel being broken away to reveal details of construction of the auger assembly;

FIG. 2 is an enlarged, fragmentary, longitudinal cross sectional view through the left end of the auger assembly illustrating internal details of construction;

FIG. 3 is a similarly enlarged, fragmentary longitudinal cross sectional view of the opposite, right end of the auger assembly;

FIG. 4 is a transverse, vertical cross sectional view through the left end of the header just inboard of the drive mechanism on the header revealing internal details of construction of the auger assembly;

FIG. 5 is an enlarged, fragmentary isometric view of the auger assembly illustrating the relationship between a flex limiter and a finger shaft of the assembly;

FIG. 6 is an exploded isometric view of a flex limiter illustrating details of construction; and

FIG. 7 is an enlarged, fragmentary longitudinal cross sectional view through the auger assembly illustrating the relationship between a flex limiter and its finger shaft.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

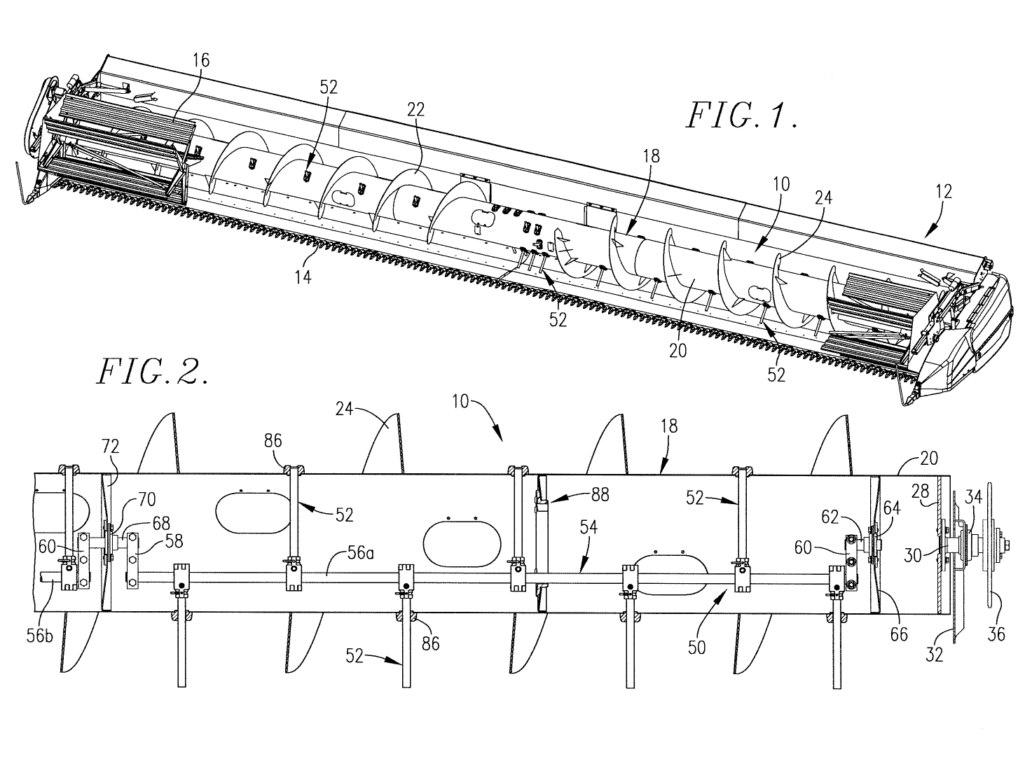

In FIG. 1 a retracting finger auger assembly 10 in accordance with the present invention is shown as part of a grain harvesting header 12 having a sickle 14 for severing standing crop materials from the ground. A rotary reel 16 assists in such severance and helps feed the severed materials rearwardly to auger assembly 10. It will be appreciated, however, that the principles of the present invention are not limited to the particular header 12 selected for illustration and that such principles can be used in a variety of different header constructions and auger assemblies.

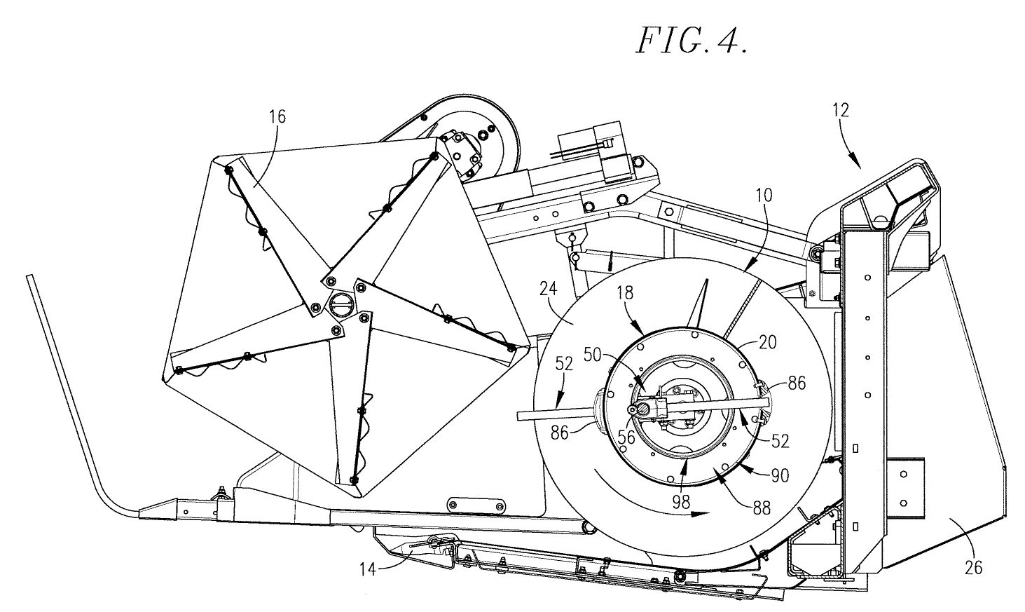

In the illustrated embodiment, auger assembly 10 extends substantially the entire width of header 12 and includes a long auger tube 18 having a cylindrical sidewall 20. Oppositely inclined auger flighting 22 and 24 on opposite left and right halves of the tube 20 are disposed to converge cut crop centrally of header 12 for subsequent discharge rearwardly therefrom into a feeder house 26 or the like (FIG. 4) of a combine harvester (not shown) to which header 12 is attached.

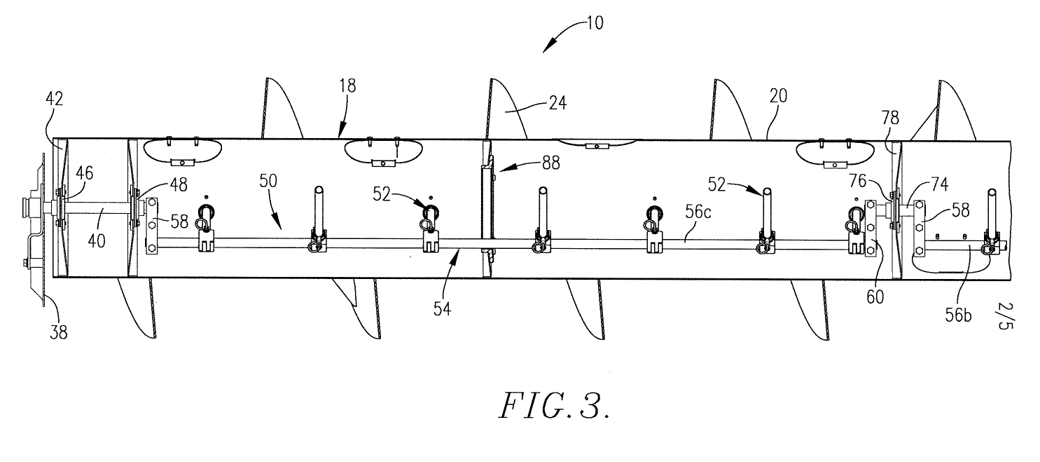

Auger tube 18 is supported at its opposite ends for driven rotation about the longitudinal axis of tube 18. In this respect, the left end of auger tube 18 as illustrated in FIG. 2 has an end panel 28 fixed to sidewall 20, the end panel 28 in turn having a stub shaft 30 fixed axially thereto and projecting outwardly therefrom. Stub shaft 30 is rotatably supported by a bracket 32 on the header and a bearing assembly 34, and a sprocket 36 is attached to the outer end of stub shaft 30 for receiving driving power from a chain drive (not shown) and utilizing such input to rotate tube 18.

At the opposite, right end of auger tube 18 as illustrated in FIG. 3, a bracket 38 on the header carries a normally stationary stub shaft 40 that projects from bracket 38 into the end of auger tube 18 coaxially with the longitudinal axis of tube 18 and stub shaft 30. A pair of axially spaced bulkheads 42 and 44 within the right end of auger tube 18 are provided with bearing assemblies 46 and 48 respectively for the purpose of rotatably supporting auger tube 18 on stationary stub shaft 40. Thus, the right end of auger tube 18 is rotatably supported on stub shaft 40, which remains stationary, while the left end of auger tube 18 rotates with stub shaft 30 which, in turn, is driven by sprocket 36.

Auger assembly 10 further includes a retracting finger mechanism 50 that broadly includes two primary components, i.e., a set of retracting fingers 52 and a stationary crank shaft 54 that carries fingers 52. In the illustrated embodiment, fingers 52 are located generally along the full length of auger tube 18, although it is to be appreciated that the principles of the present invention are not limited to this arrangement. For example, it is possible that fingers 52 might be provided only in the central region of auger tube 18, leaving the two flighted portions thereof essentially finger-free. In any event, in the illustrated embodiment, crank shaft 54 is full length of auger tube 18 and is divided into three sections, comprising a right section, a central section and a left section.

Each such section of crank shaft 54 includes a laterally offset shaft portion comprising a finger shaft 56 that extends parallel to the axis of rotation of auger tube 18 in eccentric relationship therewith. Opposite ends of each offset finger shaft 56 are provided with cranks 58 and 60 that are in turn fixed to portions of crank shaft 54 that are coaxial with the axis of rotation of auger tube 18.

Starting with the left end of left finger shaft 56a as illustrated in FIG. 2, it will be seen that crank 60 is fixed to a stub shaft 62 journaled by a bearing assembly 64 in a support bulkhead 66 that is fixed to sidewall 20 of auger tube 18. At the opposite end of finger shaft 56a in FIG. 2, crank 58 is fixed to a stub shaft 68 that is journaled by a bearing assembly 70 carried by a support bulkhead 72 fixed to sidewall 20. Stub shaft 68 projects axially through support bulkhead 72 into the central area of auger tube 18 and at that location is fixed to the crank 60 associated with the central finger shaft 56b. As shown in FIG. 3, the central finger shaft 56b at its right end has its crank 58 fixed to a stub shaft 74 that is journaled by a bearing assembly 76 in a support bulk head 78 fixed to sidewall 20. After passing through bulkhead 78, stub shaft 74 fixedly connects to crank 60 associated with the right finger shaft 56c, which is fixed at its outboard end to its other crank 58. Crank 58 of right finger shaft 56c is in turn fixed to stub shaft 40 projecting inwardly from header support structure 38.

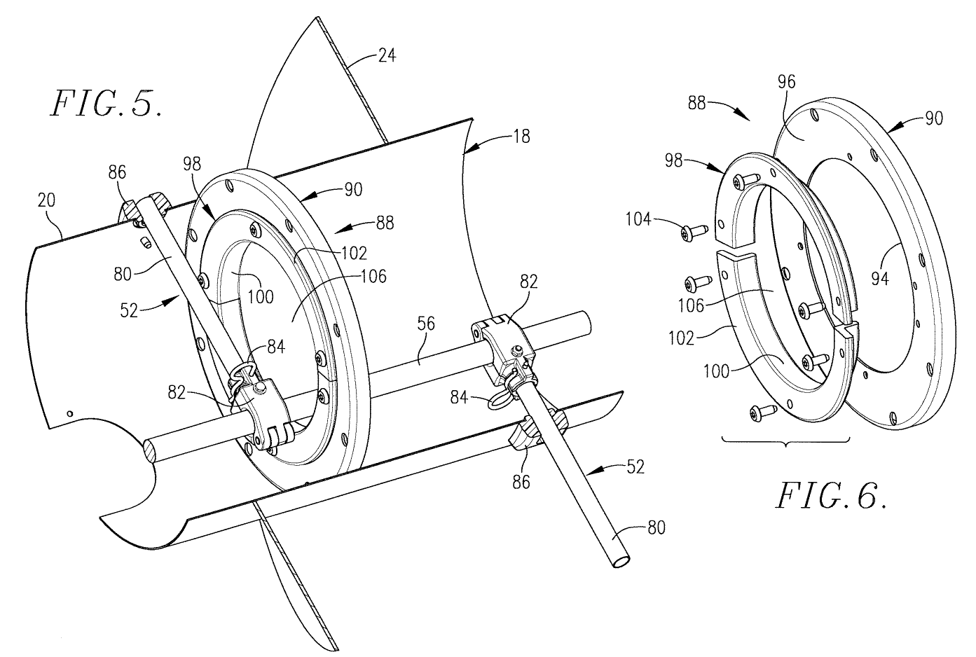

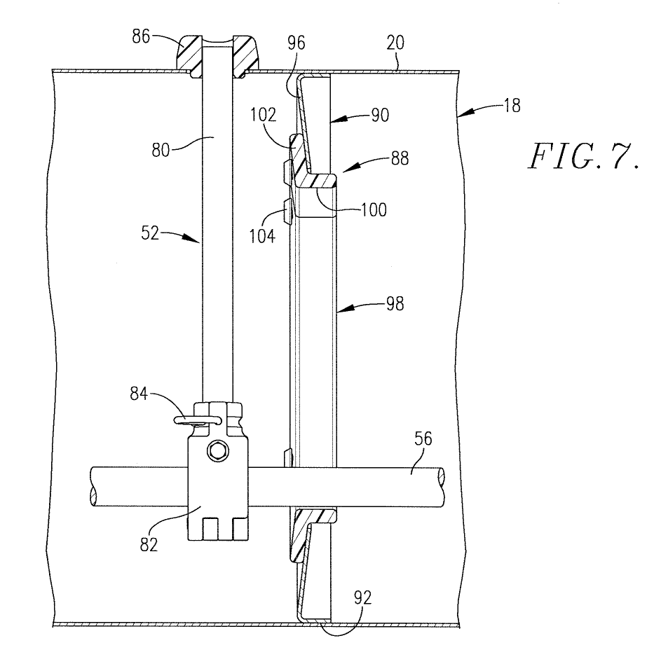

Each of the fingers 52 is pivotally mounted on its finger shaft 56 for rotation about the axis of finger shaft 56. As illustrated perhaps best in FIGS. 5 and 7, each finger 52 preferably comprises a metal finger tube 80 that is replaceably received within a plastic holder 82 rotatably carried on finger shaft 56. A cotter pin 84 or the like may be used to releasably retain each finger tube 80 within its corresponding holder 82.

The outer end of each finger tube 80 projects through and is slidably received by a guide 86 fixedly secured within a mounting hole in the sidewall 20 of auger tube 18. In the left and right portions of auger tube 18, finger guides 86 are disposed at diametrically opposed and axially spaced positions along auger tube 18, while in the central portion of auger tube 18, finger guides 86 are preferably arranged in side-by-side groups of two or three at suitable intervals about tube 18.

As a result of this construction, when auger tube 18 is rotated by drive sheave 36 in a counterclockwise direction viewing FIG. 4, crank shaft 54 remains stationary but fingers 52 are driven about their finger shafts 56 by the rotating tube 18. Due to the offset relationship between finger shafts 56 and the axis of rotation of auger tube 18, fingers 52 sequentially extend and retract during each complete revolution. Because auger tube 18 rotates in a counterclockwise direction viewing FIG. 4 and the finger shafts 56 are offset toward the front, fingers 52 are caused extend forwardly along the front of auger tube 18 and to retract along the backside thereof. At other locations between these two extremes, the fingers are either being retracted (as they move down and under the auger tube) or extended (as they move up and over the auger tube).

It will be appreciated that, particularly in the left and right sections of the auger tube 18, finger shafts 56 are quite lengthy compared to the diameter of such shafts. Therefore, there is a tendency for finger shafts 56 to bounce and flex during rotation of auger assembly 10. Such action is particularly likely to occur when some of the fingers 52 encounter unanticipated loads. For example, when fingers 52 are fully extended on the front side of auger tube 18, the outboard portions of fingers 52 have significant mechanical advantage over the inboard portions thereof. Thus, a load experienced by the exterior portion of the finger can cause the finger to fulcrum about the finger guide 86 and flex the finger shaft 56 in a way that may seek to retract fingers 52 on the opposite side of auger 18 more than their intended amount. If one of the fingers 52 becomes retracted so far that it is pulled back inside auger tube 18, it can punch a hole in the auger tube as it attempts to extend during the extension phase of the finger, or cause catastrophic failure of the mechanism.

In accordance with the present invention, each of the left and right finger shafts 56a and 56b is provided with at least one flex limiter 88 between the supporting bulkheads for the finger shaft. Each flex limiter 88 includes a transverse, annular, metallic member 90 having a circular periphery 92 that is welded or otherwise permanently affixed to the interior surface of sidewall 20 approximately mid-length of the finger shaft 56a or 56c. Annular member 90 extends at right angles to the longitudinal axis of auger tube 18 and has a centrally located, enlarged circular opening 94 through which the finger shaft 56a or 56c passes. Opening 94 is concentrically disposed with respect to the axis of rotation of auger tube 18. A front face 96 of member 90 slopes gradually in the axial direction as opening 94 is approached.

Flex limiter 88 further includes an anti-friction guide ring 98 disposed concentrically within annular member 90 and securely fastened thereto. In one preferred form of the invention, guide ring 98 is constructed from ultra high molecular weight (UHMW) polyethylene, although other materials may also be utilized. Guide ring 98 circumscribes the corresponding finger shaft 56a, 56b and has a radially inner surface 100 that is normally slightly spaced radially outwardly from the outer extremity of finger shaft 56 so that surface 100 does not normally contact finger shaft 56 during rotation of auger tube 18. However, in the event of slight outward flexing of finger shaft 56, surface 100 comes into engagement with shaft 56 and prevents further flexing thereof, thereby also preventing further retraction of those fingers 52 that are already fully retracted to the extent illustrated in FIGS. 5 and 7, for example. Longer than momentary engagement of finger shaft 56 with surface 100 can be accommodated, if necessary, due to the anti-friction nature of the material from which guide ring 98 is constructed. Inner surface 100 defines a circular hole 106 that is concentric with opening 94 and has a slightly smaller diameter.

Guide ring 98 also has a circumferential, radially outwardly extending lip 102 integral with surface 100 and overlying a portion of the front face 96 of transverse member 90. Lip 102 serves as the means by which guide ring 98 is secured to annular member 90, having a plurality of suitable fasteners 104 that project through lip 102 and into retaining engagement with member 90. In one preferred form of the invention, fasteners 104 may take the form of machines screws. Preferably, guide ring 98 is formed from two semi-circular halves, as shown particularly in FIG. 6.

It will be noted that each flex limiter 88 does not interfere with rotation of auger tube 18 or extension and retraction of fingers 52. In normal operating conditions, limiters 88 do not make engagement with their finger shafts 56a, 56c. However, in the event that any of the fingers 52 experiences unusual loading such as would normally cause a shaft 56a or 56c to flex, the corresponding limiter 88 is well positioned to engage the slightly flexed shaft before it can move to such an extent that damage or catastrophic failure can occur.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. In a retracting finger auger assembly, the improvement comprising:
an elongated auger tube adapted for rotation about the longitudinal axis of the tube and having a cylindrical sidewall;
a stationary crankshaft housed within the tube and having at least one longitudinally extending shaft portion that is offset eccentrically with respect to said longitudinal axis,
said offset shaft portion being supported by a pair of longitudinally spaced supports;
at least one finger pivotally attached to said offset shaft portion and projecting laterally through said sidewall for rotation by the tube about the offset shaft portion and consequential extension and retraction relative to the sidewall as the tube rotates; and
a flex limiter located between said supports in disposition to block flexing of said shaft portion to an extent that would otherwise result in over-retraction of the finger relative to the tube.

2. In a retracting finger auger assembly as claimed in claim 1,
said flex limiter circumscribing said offset shaft portion and being fixed to said sidewall for rotation with the tube.

3. In a retracting finger auger assembly as claimed in claim 2,
said flex limiter including shaft-engaging portions constructed from an anti-friction material.

4. In a retracting finger auger assembly as claimed in claim 3,
said anti-friction material comprising ultra-high molecular weight polyethylene.

5. In a retracting finger auger assembly as claimed in claim 1,
said flex limiter comprising a transverse member fixed to the interior of said sidewall and having a clearance hole,
said flex limiter further comprising an anti-friction guide ring fixed to said member in said hole and circumscribing said offset shaft portion in slightly space relation to the offset shaft portion.

6. In a retracting finger auger assembly as claimed in claim 5,
said anti-friction guide ring being constructed from ultra-high molecular weight polyethylene.

7. In a retracting finger auger assembly as claimed in claim 5,
said anti-friction guide ring comprising a pair of opposite, semi-circular guide ring halves secured to said transverse member in a manner to render the anti-friction guide ring annular in configuration.
